(19) United States
(12) Patent Application Publication
(10) Pub. No.: US 2006/0224667 A1
(43) Pub. Date: Oct. 5, 2006

(54) Method and system for communication between parties

(75) Inventors: Asaf Amir, Ra'anana (IL); Eran Zion, Ramat Hasharon (IL)

Correspondence Address: TIAJOLOFF & KELLY, CHRYSLER BUILDING, 37TH FLOOR, 405 LEXINGTON AVENUE, NEW YORK, NY, 10174, US

(73) Assignee: Tigon Software Ltd., Ra'anana (IL)

(21) Appl. No.: 10/569,212

(22) PCT Filed:
(86) PCT No.: PCT/IL04/00770

Related U.S. Application Data
(60) Provisional application No. 60/497,576, filed on Aug. 26, 2003.

(51) Int. Cl. G06F 15/16

(52) U.S. Cl. 709/204

(57) ABSTRACT

A method for filling a psychological gap during the communication of at least two people considering making a date, the method characterized by playing a dating game by the at least two people on a game board having a plurality of spaces. The dating game method includes obtaining a game board by each player. The method also includes picking a game piece by each player that represents him/her during the game, moving alternately by the players of his/her game piece on the game board from space to space from start to finish, wherein the number of spaces that the game piece moves is indicated by a random number indicator, and wherein the spaces on the board belong to a plurality of categories and picking a category card by a player according to the category associated with the space on which the game piece lands, wherein the category card is printed as a question card having at least one question or an activity card showing a timed activity for him/her to carry out, such that at the end of the game the players decide whether to go out on a real date.

### FIELD OF THE INVENTION

This invention relates to a method and system for communication between different players through a communication network, and in particular, for a method and system for playing a game via various media, said game intended to determine whether to arrange a date between the players.

### BACKGROUND OF THE INVENTION

Dating games enjoy popularity in all forms. Simple games such as “spin-the-bottle,” are perhaps centuries old. “The Dating Game” was a popular show on American television during the 1960's and 70's. Marcus filed US Pat. Applic. No. 20020135126 for a Compatibility Board Game. A board game is disclosed where, through a series of questions, players reveal various character traits to others, and learn various character traits of others, with the potential for finding compatibility between two or more of the players.

The questions asked of a particular player are determined by the location of the player's game piece on a board including a plurality of sequential spaces. The spaces include some visual aspect to designate the space as belonging to one or more categories. A random number is obtained by a random number generator, such as a die, and the player's piece is moved the number of spaces indicated by the generated number. The player is then asked one or more questions, or asked to perform an act, depending on the space on which the player's piece lands.

One of the Internet networks is a so-called “World Wide Web” (“WWW”). One of the popular applications for the WWW is an Internet dating service that provides matching people by computer. Typically, a user that enters the virtual dating service via a communication network (e.g., the Internet) goes through the following basic steps shown in FIG. 1, as is known in the prior art. First, the user has to fill out a questionnaire for setting search preferences 110 of the date, e.g.: sex, age, country, zip code, etc. (step 1). Thereafter, the user sends an inquiry to the system and conducts a search 120 (step 2). Then, the data obtained in the search are sorted (step 3), and the user can view (step 4) the profiles 140 of the members of the dating service with whom he/she can establish a communication. The user can initiate a first contact 150 (step 5) with their “ideal” date via one of the Internet features such as e-mail, chat or messenger, which are provided by the Internet dating service on the dating WWW site. For example, a first contact can be started by using an opening sentence like: “I like your profile. Please contact me.” The communication 160 (step 6) initiated between the users of the dating service can, inter alia, include such conversation subjects as work, studies, family, former relationships, etc.

After the viewing of their profile and contacting them through the system, the main difficulty of the users on the conventional WWW dating services is creating an interesting, enjoyable and flowing conversation with the member with whom they are communicating. In the conventional virtual meeting there is a psychological difficulty (gap) between the steps of initiating a first contact and a next step 170 (step 7) that should follow after communication 160 step 6. The user is left alone to develop a creative and flowing conversation that represents him/her in an appealing and interesting way in the eyes of his/her virtual dating partner. In addition, in this virtual dating process, it is difficult for the user to reveal his/her true personality, because they are “locked” in to a given conventional set of questions asked at the romantic virtual conversation meeting.

In order to verify the difficulties that are raised on such romantic meetings, virtual or traditional, and the attitudes towards these difficulties encountered by a romantic couple, personal interviews were conducted with about 50 couples after their first date. The results of these interviews reveal that boredom and disappointment at the first communication often lead to avoiding a second date. The set of questions asked at the first meeting is usually similar to a job interview. The communicating players try to avoid conversation topics that could cause an uncomfortable feeling.

Accordingly, there is a need to distract the couple from the psychological barriers and information gap 180 of the generally embarrassing situation on a first date, to a funny, meaningful and challenging game that can give the couple a good chance to get to know one another.

### SUMMARY OF THE INVENTION

Accordingly, it is a principal object of the present invention to provide a novel method to fill the psychological gap in the communication of first-dating players, and provide a method and system for playing a funny, meaningful and challenging dating game at the meeting.

It is a further object of the present invention to improve the results obtained by online dating services.

A method is disclosed for filling a psychological gap during the communication of at least two people considering making a date, the method characterized by playing a dating game by the at least two people on a game board having a plurality of spaces. The dating game method includes obtaining a game board by each player. The method also includes picking a game piece by each player that represents him/her during the game, moving alternately by the players of his/her game piece on the game board from space to space from start to finish, wherein the number of spaces that the game piece moves is indicated by a random number indicator, and wherein the spaces on the board belong to a plurality of categories and picking a category card by a player according to the category associated with the space on which the game piece lands, wherein the category card is printed as a question card having at least one question or an activity card showing a timed activity for him/her to carry out, such that at the end of the game the players decide whether to go out on a real date.

The main purpose of the game is to enable a dynamic flow of words that would be enjoyable for the couple during the first meeting online and to motivate the players to reveal themselves naturally and easily without the risk of being embarrassed or indecent. The purpose of the invention is achieved through various questions answered by the players and activities carried out by the players. The questions and activities are suggested by category cards including questions which each player will pick.

In one embodiment of the present invention, the dating game is an Internet Based Romantic Dating Game that offers an enjoyable, creative, entertaining and original alternative to the boring set script that occurs on very virtual romantic meeting.

The game will be referred to herein under the name “PlayDate™”. The PlayDate™ game fills the “online dating process gap” with enjoyable, creative and original content and offers the couples the ability to overcome their first dating conversation and beyond.

According to another embodiment of the invention, the players play a board game in which players reveal various character traits to each other through a serious of questions or common activities requested by the game. According to one embodiment of the invention, the board of the game is a virtual board monitored by a computer. According to another embodiment of the invention, the board of the game is a real board obtained by each player before the play.

Other communication ways can be used within the scope of the invention besides the Internet and a board game. For example, communication between the dating partners can be conducted by using mobile phones, e.g., cellular phones, with or without Short Message Service (SMS). Moreover, the communication between the dating partners can be conducted at a television show or with each participant using an interactive television, etc.

Continuing with the board game embodiment, each player picks a game piece that represents him during the game. According to the game, the game piece is moved on the game board from space to space from start to finish. The number of spaces that the piece has to move is indicated by a random number indicator, e.g., a die. The spaces on the board belong to one or more categories. Depending on the space on which the game piece lands, the player picks a category card, which either asks him a question printed on the card or to carry out a time activity either alone or together with another player. Preferably, more than one question is presented on each card, so that the second player could select which of the questions the first player has to answer. When the board of the game is a real board, the second player can, for example, select the question by operating a spinner.

Alternatively, when the board of the game is a virtual board, the number of the question can be indicated by a second random number indicator.

The questions and activities, which the players have to carry out, belong to several timed categories, for example: (i) General or introductory questions; (ii) Activities; and (iii) Intimate questions.

Accordingly, at the beginning of the game, the questions that belong to the general or introductory category will be asked. In this case, the answers of a player give a preliminary idea of the player's personality. Examples of the questions include, but are not limited to the following:
What's your favorite TV show?
Would you rather accept expensive gifts or gifts invested with time and effort?
About what subjects do you feel you can provide consultation?
What skills would you like to learn, but haven't learned yet?
If you had to plan a romantic vacation for us, where would it be?

After the introduction, the players can be provided with the time activities from the second category. In this case, the situation transfers from “one-on-one” to “one-with-one.” In other words, either one or both players participate in common timed activities. Examples of the timed activities include, but are not limited to, the questions as follows.
Personal Item Activity: A player has to present one personal item and explain why he/she has it, where he/she got it and why it is so precious to him/her.
Card Acivity: A player plays 3 rounds of BlackJack.
Pencil And Notebook Activity: One player draws (without words) the next phrase of a song and a second player has to figure it out—“Love Will Conquer All.”
Role Play—Car: The players have only one car and tomorrow they need to go in two different directions. No one is willing to give up. One player has to try to convince the other.
Role Play−Present: “You bought me a present I do not like. I try to avoid using it and you are offended.” Explain your positions to each another.

Finally, the questions that belong to the intimate questions category are asked. The final stage of the game can be based on the first two stages for revealing the “inner layers” of the players. Examples of the questions include, but are not limited to, the questions as follows.
Name the 3 most sensitive parts of your body.
Do you believe in “Make-Up Sex”?
Would you rather make love in the light, candle light or dark?
Generally, do you believe in doing sex on your first date?
   Unique Advantages of the Method and System of the Present Invention:
   1. Guides the couple through the 3 basic steps of a great virtual meeting:
A. Breaks the ice and creates an interesting, fun and easygoing introduction.
B. Organizes them to cooperate on creative tasks and activities.
C. Allows them to comfortably reveal the inner layers of their personality.
   2. Motivates the players to reveal themselves naturally and easily with no “risk” of being embarrassed or indecent.
   3. Is not just a simple list of questions but a content initiator which allows the player to ask all sorts of questions he/she would have never asked, but would have wanted to be answered.
   4. Fills the “Online Dating Process Gap” with enjoyable, creative and original content and offers the couples the ability to facilitate their first dating conversation and continue further.
   5. Unlike any other game, PlayDate™ has a known common result (a date) and therefore it focuses on the process that generates a cooperative game between the players.

The game provided by the invention is a creative and important strategic step that will improve upon any online dating service in initiating a first date as a content molder/initiator and not just as the matchmaker.

Competitive Advantages:

Enhances the interaction and cooperation.
Develops a better personal communication.
Contributes to the position of any online dating service site as a top innovator and strengthens its unique image.
Answers the expectations of members to find what they are looking for.
Enhances the use of existing members.
Increases the amount of members and subscribers.
Creates loyalty to the service.
   Content Possibilities of the Questions:
   Past/Present/Future
   Hobbies
   Religion &-Beliefs
   Family &-Friends
   Love &-Romance
   Career &-Education
   Intimacy

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1a is a prior art schematic flow diagram of the basic steps carried out by a member of an Internet dating service, as described hereinabove;

FIG. 1b is a prior art screen shot of photos of three women who are members of an Internet dating service, and who are now online, and which further illustrates an example of an implementation of the PlayDate™ Internet Game of the present invention;

FIG. 2a is a schematic block diagram of an exemplary Internet Game system, using the Web and various media alternatives, according to the principles of the present invention;

FIG. 2b is a schematic block diagram of the exemplary Internet Game system of FIG. 2a, with added details, according to the principles of the present invention;

FIG. 3a illustrates an overview of PlayDate™ game screen for the Internet Game of the present invention;

FIG. 3b Illustrates a close-up of the playing partner shown in FIG. 3a for the Internet Game of the present invention;

FIG. 3c illustrates a close-up of the chat box with dialog shown in FIG. 3a for the Internet Game of the present invention;

FIG. 3d illustrates a close-up of each gesture shown in FIG. 3a for the Internet Game of the present invention;

FIG. 3e illustrates close-up views of the Love Genie, or moderator, as the character appears on the screen shown in FIG. 3a for the Internet Game of the present invention;

FIG. 4 shows an exemplary layout of the board game embodiment, constructed in accordance with the principles of the present invention;

FIG. 5 shows a first portion of the board game shown in FIG. 4;

FIG. 6 shows a second portion of the board game shown in FIG. 4;

FIG. 7 shows a third portion of the board game shown in FIG. 4;

FIG. 8 shows an example of the card from the first category with Initial General/lntroduction/Background Questions off the board game shown in FIG. 4;

FIG. 9 shows an example of the card from the second category with Timed Activities & “Role Play” in playing the board game shown in FIG. 4;

FIG. 10 shows an example of the card from the third category with Sex & Intimate & Relationship Questions in playing the board game shown in FIG. 4;

FIG. 11 shows a starting space of the board game shown in FIG. 4;

FIG. 12 shows the starting space shown in FIG. 11 with a game piece placed by the player in the board game shown in FIG. 4;

FIG. 13 shows an exemplary spinner for generating a random number, as practiced in playing the board game shown in FIG. 4;

FIG. 14 shows an ending point on the board game shown in FIG. 4; and

FIG. 15 shows a timer, as used in the board game shown in FIG. 4.

### DETAILED DESCRIPTION OF SPECIFIC EMBODIMENTS

The principles and operation of a method and an apparatus according to the present invention may be better understood with reference to the drawings and the accompanying description, it being understood that these drawings are given for illustrative purposes only and are not meant to be limiting.

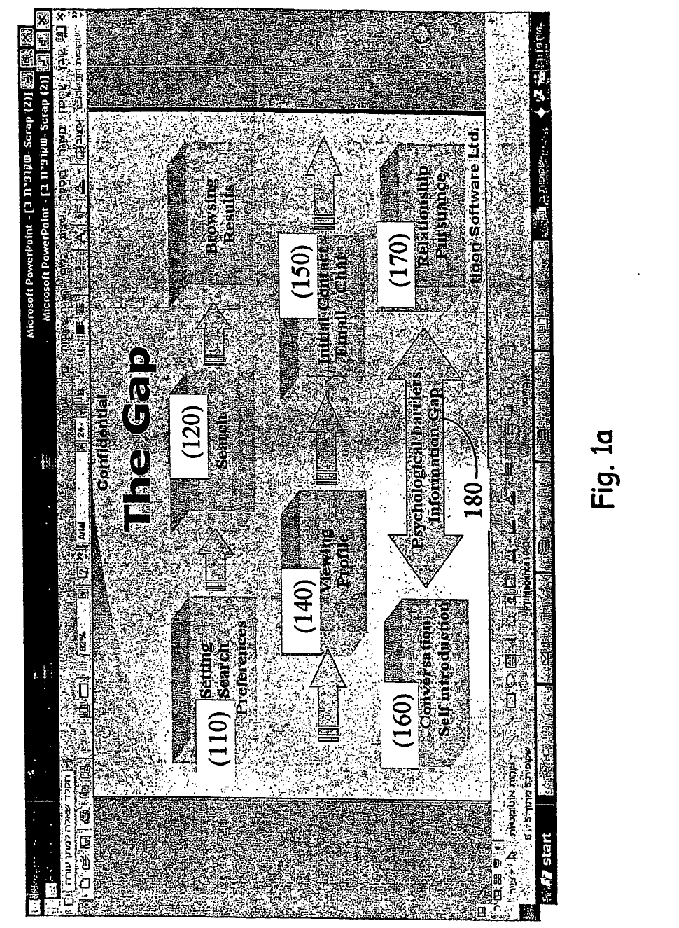

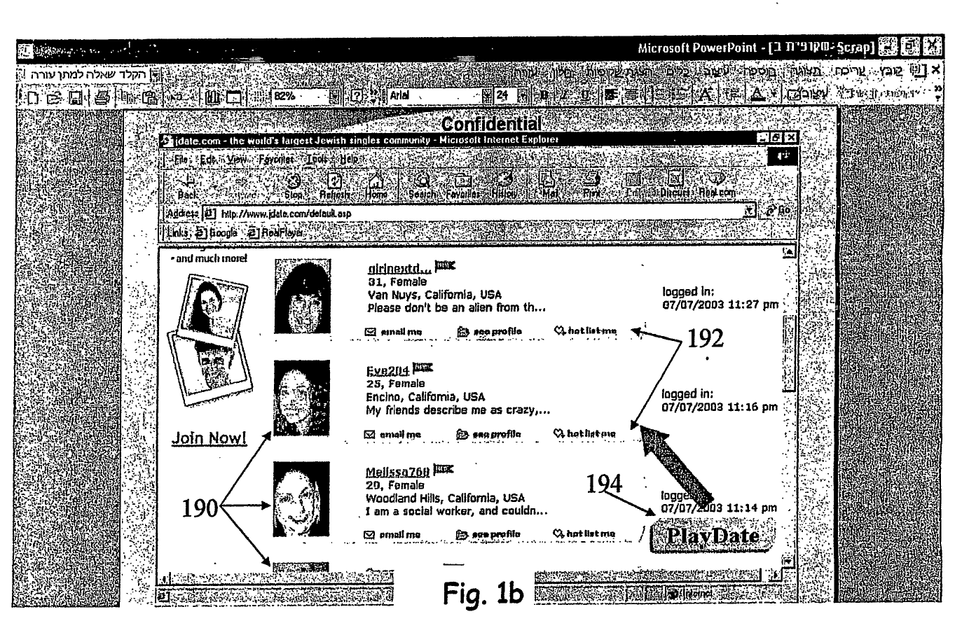

FIG. 1b is a prior art screen shot of photos of three women 190, who are members of an Internet dating service, and are now online. The prior art conventional Web page typically uses a bar 192 with the three hyperlinks shown: email me; see profile; and hot list me. The present invention adds another button: PlayDate™ 192, which will activate a hyperlink to the PlayDate™ game screens

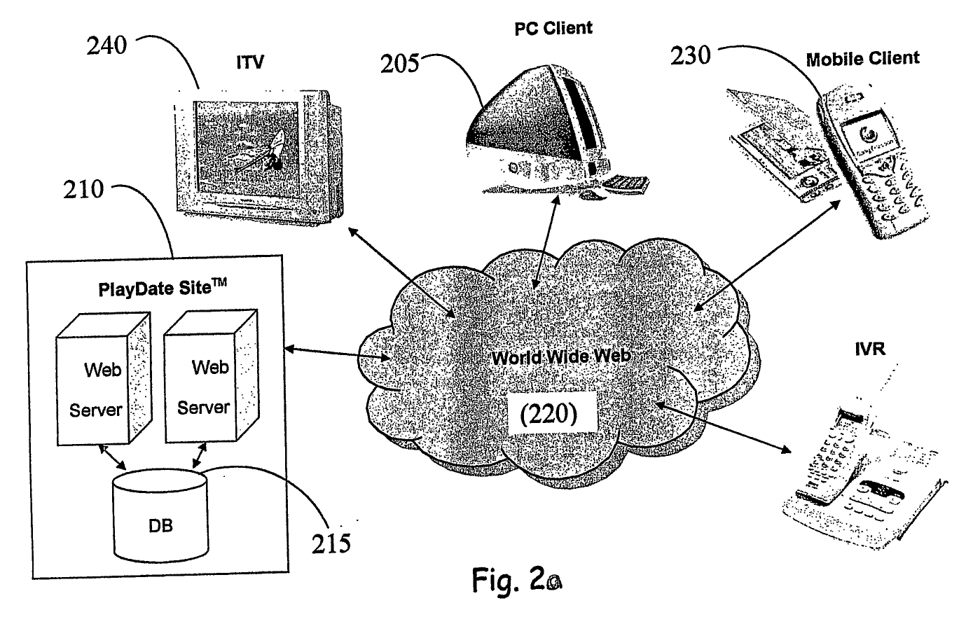

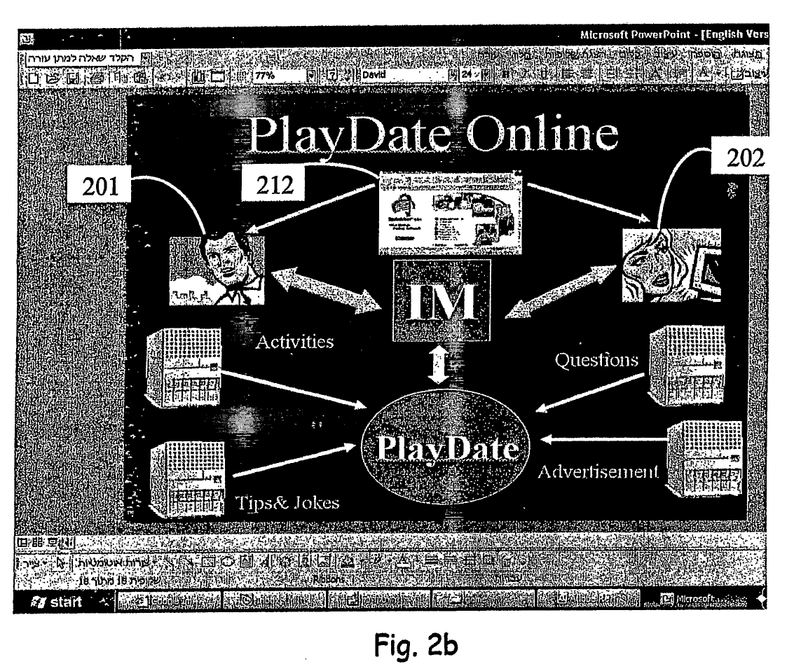

FIGS. 2a and 2b are schematic block diagrams of an exemplary realization of the invention. A first player, the inviter 201, and a second player, the invited 202, are each using a personal computer (PC) 205. They are both connected to an Online Dating Site 210 via the Internet 220, such as wwwjdate.com, and access a dating Web page. The user's profiles are stored in a Database of users 215.

It is apparent that although the example of communication between the dating partners was shown for communication by using the Internet, the invention is not limited by this application. Other communication ways can be used within the scope of the invention. For example, communication between the dating partners can be conducted by using mobile phones 230, e.g., cellular phones, a video console with a set top box or an interactive TV 240. Likewise, the communication between the players can be conducted at a real vis-a-vis meeting. Moreover, the communication between the dating partners can be conducted on an actual television show, etc.

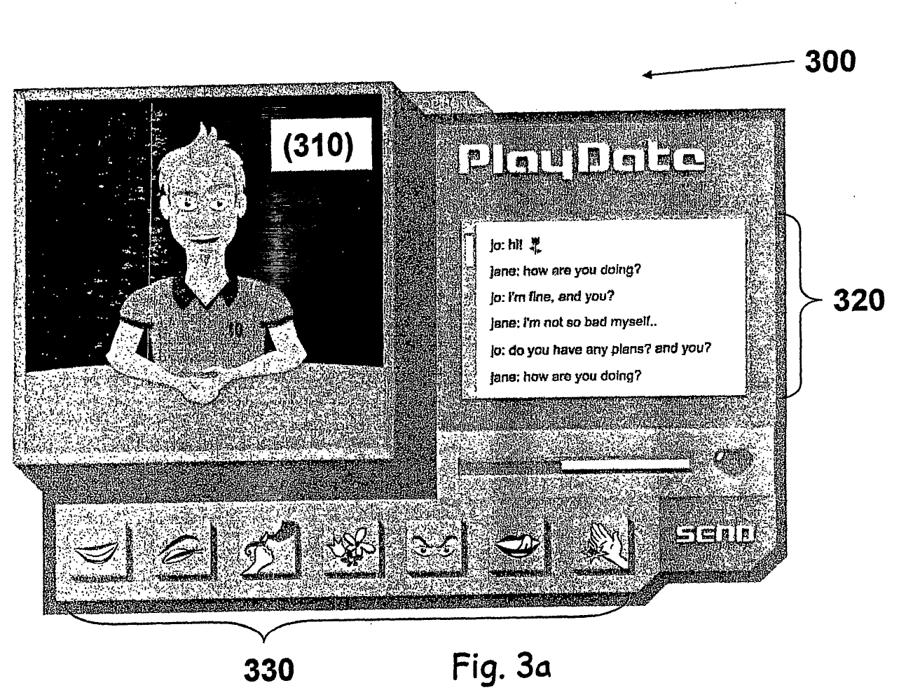

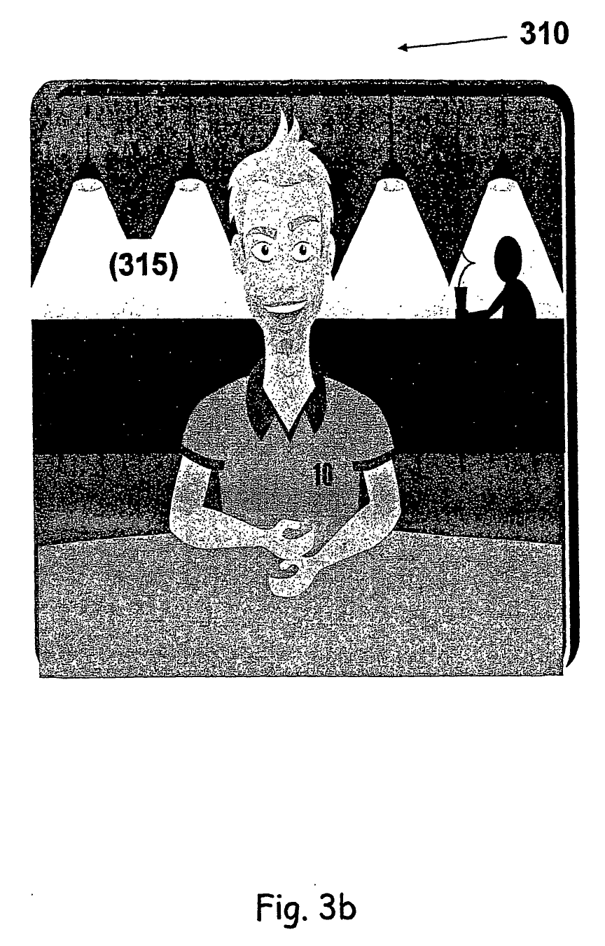

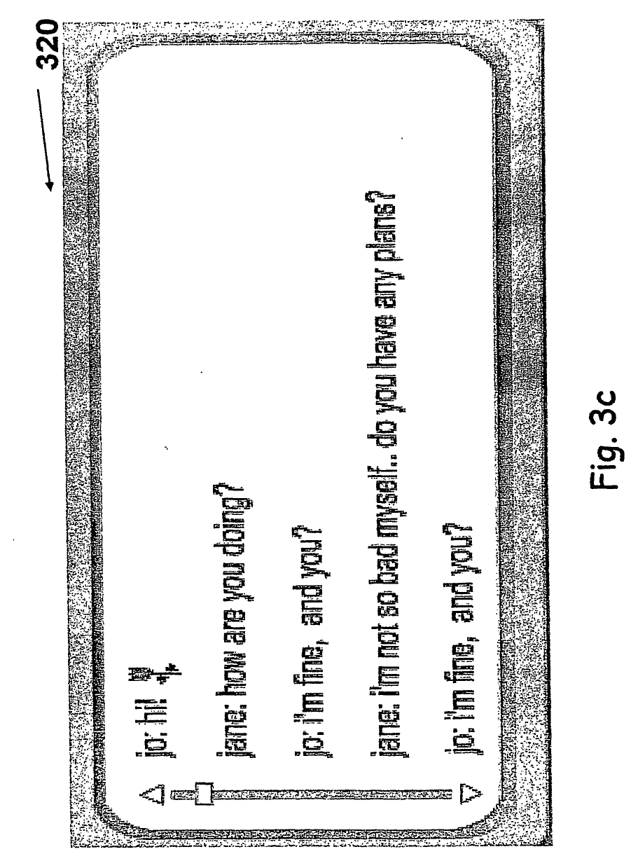

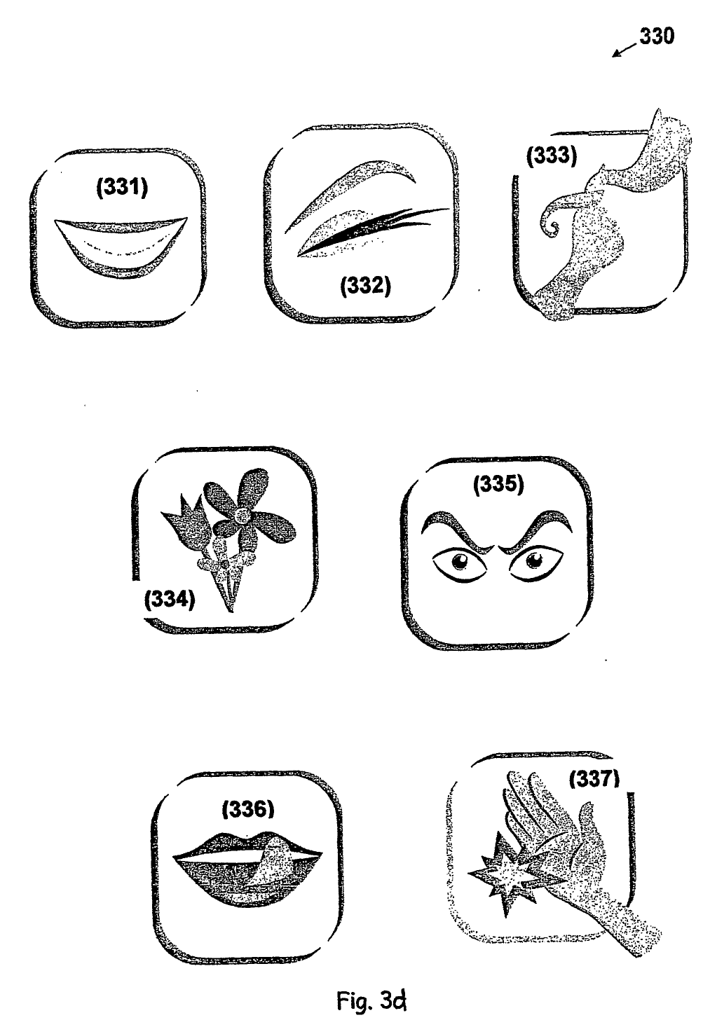

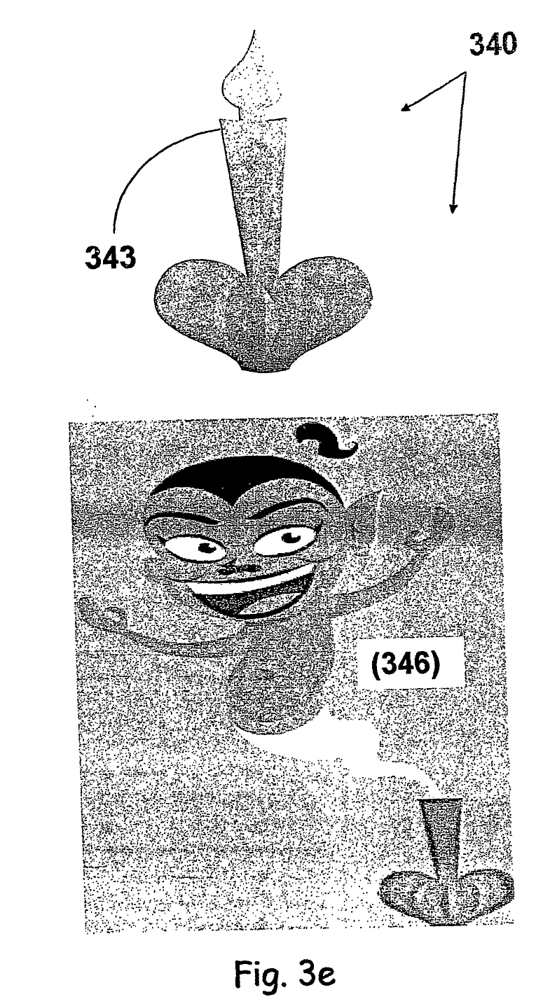

FIG. 3a illustrates the main application PlayDate™ game screen 300 for the Internet Game of the present invention, which is used in stage 5, as described below. An image is shown of one's playing partner 310. A chat box with dialog 320, a gesture bar with buttons 330 and a love mood bar 340 is also portrayed.

FIG. 3b illustrates a close-up of the playing partner 310 shown in FIG. 3a for the Internet Game of the present invention. The chosen location is seen to be a bar 315

FIG. 3c illustrates a close-up of the chat box with dialog 320 shown in FIG. 3a for the Internet Game of the present invention.

FIG. 3d illustrates a close-up of each gesture 330 shown in FIG. 3a for the Internet Game of the present invention. Gestures 330 include a smile 331, a wink 332, a hair caress 333, flowers 334, an angry expression 335, tongue-on-lips 336 and a slap 337.

FIG. 3e illustrates close-up views of the Love Genie 340, or moderator, as the character appears on the screen shown in FIG. 3a for the Internet Game of the present invention. Love Genie 340 is represented by a closed bottle before his release 343 and together with his bottle after his release 346.

Referring again now to FIG. 2, during the game, the players will use either a chat or instant messaging (IM) system for communicating with each other. The PlayDate™ game will retrieve questions and activities, which are stored in a Database of Questions. The questions and activities are displayed to the players, as described above. Moreover, the players can be presented with different tips stored in a Database of Tips. The tips can be shown during the game to the players, and be related to romance, relationships, sex and intimacy. Examples of the tips are as follows:
Look into your partner's eyes as many times as possible;
Put love notes in his/her pockets;
Before you find your prince you still have to kiss many frogs;
The goal of a dispute is to get you closer; and
Kiss him/her at any chance you get.

As can be appreciated, during the game, the users can be provided with various advertisements stored in a Database of Advertisements.

The purpose of PlayDate™ is achieved in an Internet embodiment in 5 stages as follows. Stage 5, below implements the game itself through various timed questions answered by the players, and activities carried out by the players. The questions and activities are suggested by several categories. For example, three timed categories can be utilized as: (i) General or introductory questions; (ii) Activities and compatibility; and (iii) Intimate questions.

The PlayDate™ Internet application is a Client-Server Application. All the application logic processes are carried out in the Server. This allows the application to operate on “weak” clients. In addition, it is possible to transfer and update content and logic processes for the application to other platforms, without significant changes and development.

Two or more players are needed for the PlayDate™ Application. One player, “The Inviter,” initiates the first contact, and the other player is “The Invited.” The first communication initiative could be done either outside the application, e.g., through on online dating service, or directly through the PlayDate application. Both the inviter and the invited get into the application after the invited accepted the invitation from the inviter. The application window is preferably of the size of Flash™, 800×570. In order to use the application it is preferable to install FlashPlayer™ on the client computer.

Stage-1: Opening Screen

The purpose of the opening screen is to present the name of the application, the company name and impressive graphics and animation to attract the attention of the players and to make them curious to continue using the application. On the introductory screen the players preferably provide their User Name, Password and Zip Code. During this process the program is uploaded to the client computer, including all the user information from the database, according to the User Name that was typed. On the introductory screen a “Process Bar” is also presented to show the status of the application upload.

Stage-2: Choosing a Character Image Screen

Every player will have to choose a character that will represent him/her during their use of the PlayDate™ application. In addition this screen will explain briefly about the purpose of the application and how to use it. Each player will also provide brief information about him/herself; for example Name, Height, Eye Color, Favorite Color, City they live in and a short description why he or she has chosen the specific figure to represent them.

A screen to choose a male figure and a screen to choose a female figure will be presented, along with information fields. The players will be able to choose the figure they want to represent them by using their computer mouse. Every time the player puts his/her mouse over any figure, a brief animation will present the figure to the player.
A brief summary about the application and the game course; and
Information fields: Name, Height, Eye Color, Favorite Color, City they live in and a short description why he or she has chosen the specific figure to represent them.

Stage-3: Choosing a Location Screen

After choosing a representative figure, the inviter and the invited have to choose a location for their virtual date. Only the inviter can actually choose the location, while the invited can only watch the screen. On this screen the inviter and the invited create their first conversation by asking each other where they would like to go on their virtual date.

After a short discussion, the inviter will choose a location for the meeting. The inviter will choose the location by using the mouse. Then the invited clicks on a “next” button that will take the players to Stage 4.

Stage-4: Who Vs. Who Screen or Waiting Screen

After the invited clicked on the next button, a Waiting Screen is presented. This screen will show the players the figures that they have chosen to represent them during the main application, along with information about themselves. Both the male figure and its information and the female figure and its information are presented on this screen. A process Bar shows the upload of the game. This is the first screen on which each player can “see” with who he/she will PlayDate™.

Stage-5: The Main Application Screen

PlayDate™ is based on timed romantic questions and activities by turns. The questions and activities are dictated by the application, and are suggested by several timed categories. For example, three categories can be utilized: (i) General or introductory questions; (ii) Activities and compatibility; and (iii) Intimate questions.

(i) General or Introductory Questions

In this category there are timed general informative questions basically about preferences.

(ii) Activities and Compatibility

In this category there are questions of the form: Agree/Disagree; Yes/No; and True/False by Radio Buttons. In this category the “Moderator Figure” presents the questions for the players and they individually answer the question. If their answer is the same the moderator compliments them, for example, by using a text or voice gesture 330. If the players answered differently the moderator will bring this to the attention of the players and will give them X amount of time to discuss their point of view differences. The question will be presented again at the end of the X time or by clicking on the “End Discussion” Button. If the players agree, the moderator will congratulate them. If not, the players can click “next” or they will move to the next question automatically.

(iii) Intimate Questions

In this category there are timed intimate, sexual and relationship questions.

Game Course:

At the beginning of the PlayDate™ application the moderator figure, who appears in the location earlier chosen by the players, gives the participants a brief welcome. Then the moderator asks the invited to begin the game and asks the first question. On the meeting table will be three rolling hearts and the invited will have to click on the “Arrow to choose a question heart.” After the arrow “choose a number between 1 and 3,” the heart with the matching number will open and a question will be presented to the inviter to answer.

Every time a question is presented, both players can see it and they will be able to discuss the presented question using a chat system/instant messaging (IM)/microphone/WebCam™. From the moment the question is presented the players have X amount of time to communicate with each other. From time to time the moderator appears and provides the players with tips about relationships. The moderator also explains to the players about the category they are in, and about the next category. At the end of the game the moderator comes in for the last time and thanks the players for their participation.

During the game a chat window will enable the players to talk to each other. In addition, it will be possible for the players to gesture to each other by using “The Gesture Bar,” and each participant can use the administration bar for changes or saving. After the participants have chosen their “Representative Character” for the game and their “Virtual Date Location,” they are transferred to the “Main Screen Game Application.” The moderator welcomes the participants and explains the rules of the game in general. Then the moderator explains the first category of the game and its purpose.

First Category: Timed General or Introductory Questions
1. The moderator describes the timed general or introductory questions.
2. The inviter makes a sign with his/her hand causing a “Question Machine” to start rolling.
3. The invited then chooses one of the elements that are presented on the Question Machine
4. Once the invited made his/her pick, the element is transformed into a question that the invited will have to answer.
5. The invited answers the question.
6. The turn ends when the time is up or when the invited has clicked on the “Pass” button.
7. The invited makes a sign with his/her hand causing a “Question Machine” to start rolling/spinning.
8. The inviter then chooses one of the elements that are presented on the Questions Machine
9. Once the inviter made his/her pick the element is transformed into a question that the inviter will have to answer.
10. The inviter answers the question.
11. The turn ends when the time is up or when the inviter has clicked on the “Pass” button.
12. Once every 3 questions the moderator will show up and will give the participants relationship tips.
13. After 6 question rounds (12 questions over all) the moderator shows up again and declares the end of category one and announces the beginning of the second category of the game.

Second Category: Timed Activities and Compatibility
1. The moderator describes the timed activities and compatibility category.
2. The inviter makes a sigh with his/her hand causing a “Questions Machine” to start rolling/spinning.
3. The invited then chooses one of the elements that are presented on the Question Machine
4. Once the invited made his/her pick the element is transformed into a question that the invited will have to answer.
5. In this category there are questions such as Agree/Disagree, Yes/No, True/False, answerable by clicking Radio-type Buttons. Each participant individually answers the question. If they gave the same answer the moderator will complement the players (for example by using a text or voice gesture and the turn will progress automatically. If the players answered differently the moderator will bring this to the attention of the players and will give them X amount of time to discuss their different points of view. The question will be presented again at the end of the X time, or by clicking on the “Present Question Again” Button. If the players agree, the moderator will congratulate them. If not, the turn will progress automatically.
6. Once every 3 questions the moderator will show up and will give the participants relationship tips.
7. After 6 question rounds (12 questions over all) the moderator shows up again and declares the end of category two and announces the beginning of category three of the game.

Third category: Timed Intimate Questions
1. The moderator describes the timed intimate questions.
2. The inviter makes a sign with his/her hand causing a “Question Machine” to start rolling.
3. The invited then chooses one of the elements that are presented on the Question Machine.
4. Once the invited made his/her pick, the element is transformed into a question that the Invited will have to answer.
5. The invited answers the question.
6. The turn ends when the time is up or when the invited has clicked on the “Pass” button.
7. The invited makes a sigh with his/her hand causing a “Question Machine” to start rolling/spinning.
8. The inviter then chooses one of the elements that are presented on the Questions Machine.
9. Once the inviter made his/her pick, the element is transformed into a question that the inviter will have to answer.
10. The inviter answers the question.
11. The turn ends when the time is up or when the inviter has clicked on the “Pass” button.
12. Once every 3 questions the moderator will show up and will give the participants Intimate & Sex Tips.
13. After 6 question rounds (12 questions over all) the moderator shows up again and declares the end of the game and transfers the participants to the “End Screen of the Game.”

Stage-6: End of Main Application Screen Endgame:
1. The moderator announces the end of the game
2. The moderator thanks the participants and transfers them automatically to the end screen that summarizes the game: all the gestures that were given, all the questions they agree on and disagreed on, the time they played, etc.
3. At this screen the participants will have 3 choices: 1. Play again (if click they will begin a new game) 2. “Lets date for real” (if click they will transferred to a suggestions for dating in their area) 3. Exit.

After the moderator thanks the participants, the application moves automatically to the end screen of the application. On this screen the players will be provided with a summary of their activities during the game. The players will be asked if they want to PlayDate™ again or to go on an actual date and get suggestions for a date based on their zip code. If they chose to play again, a new game will be started. If they chose to go on a date, an advertising screen with suggestions will be presented to the players.

A question box appears: “would you like to PlayDate™ again or go out on a real date?” with 2 options to choose from by radio buttons.

Board Game Application Description:

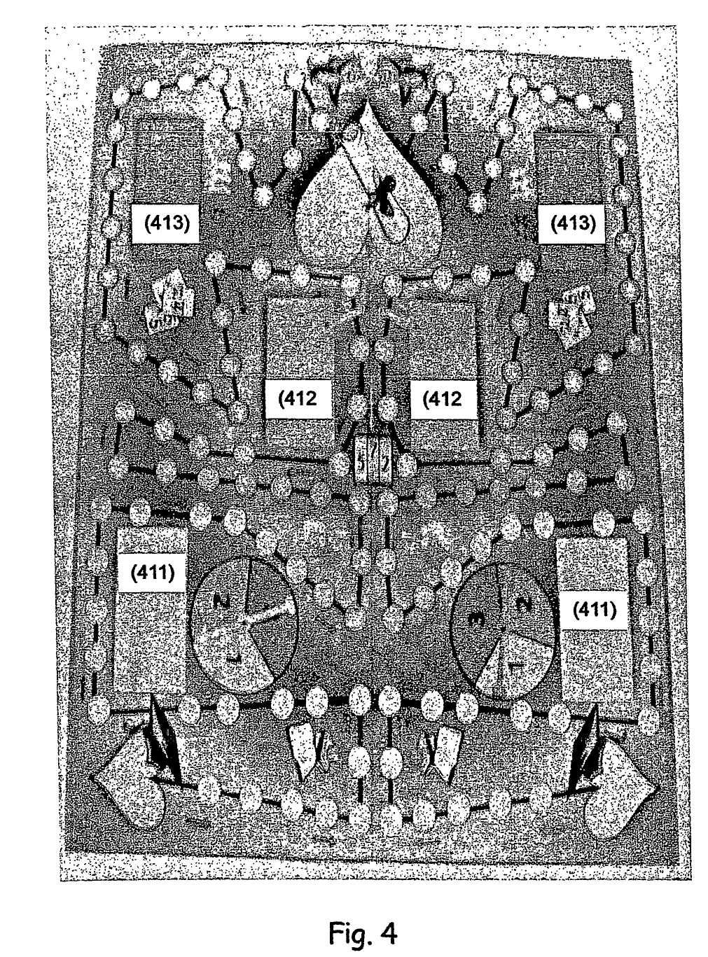

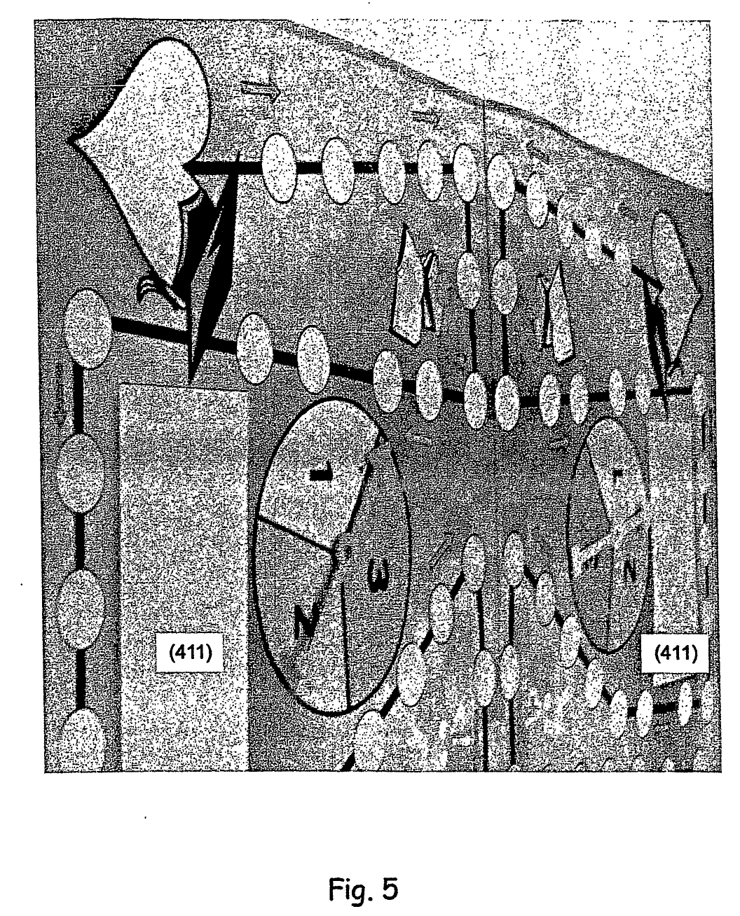

FIG. 4 shows an exemplary layout of the board game embodiment, constructed in accordance with the principles of the present invention. Regarding the track on the board, there are three “mirror-image” portions on each side of the board shown in FIG. 4, 411, 412 and 413, which are enlarged in FIGS. 5-7. Regarding the position of the cards on the board shown in FIG. 4, there are three positions for cards:
A. Initial General/Introduction/Background Questions 411;
B. Timed Activities & “Role Play” 412;
III. Sex & Intimate & Relationship Questions 413.

FIG. 5 shows a first portion of the board game shown in FIG. 4. This portion deals with Initial General/Introduction/Background Questions 411.

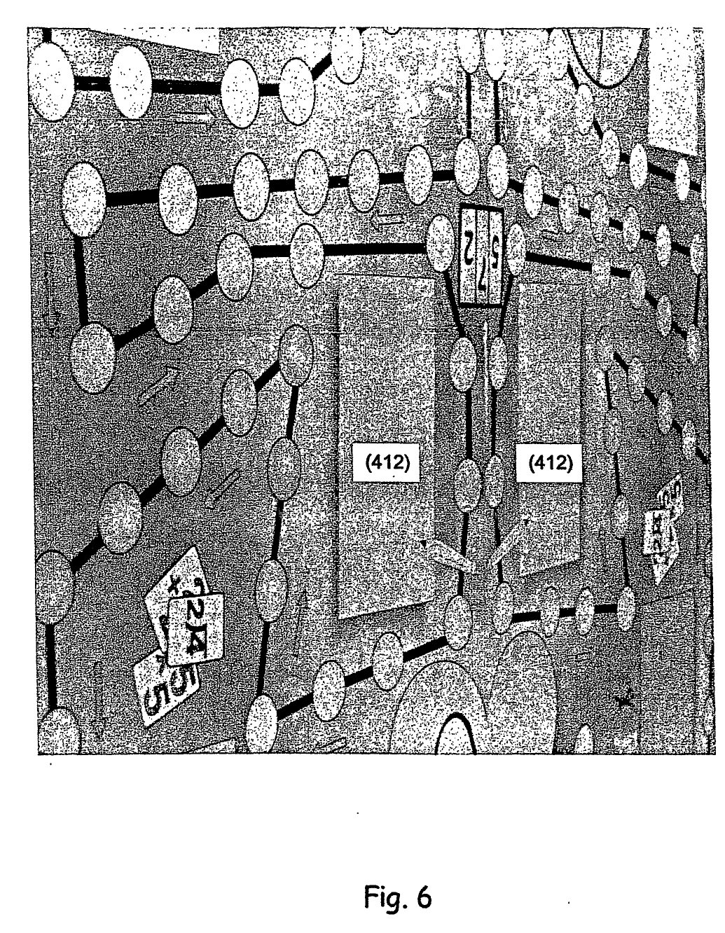

FIG. 6 shows a second portion of the board game shown in FIG. 4. This portion deals with Timed Activities & “Role Play 412.

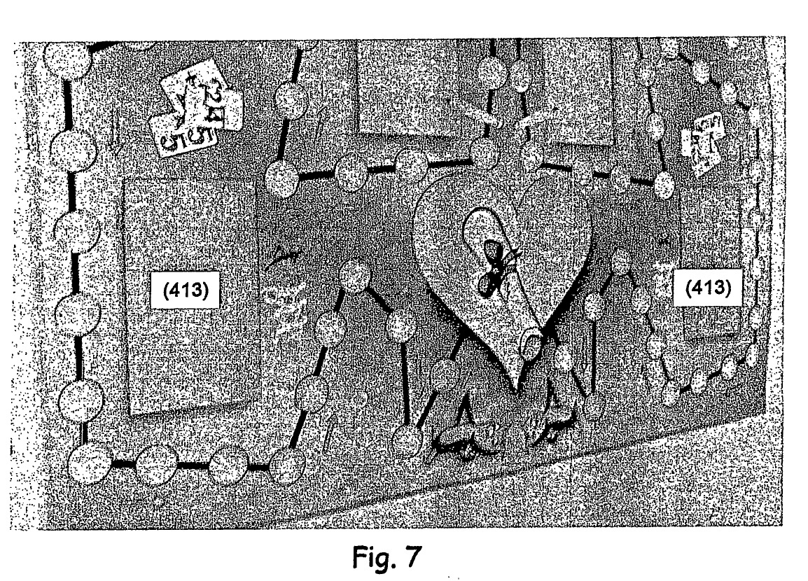

FIG. 7 shows a third portion of the board game shown in FIG. 4. This portion deals with Sex & Intimate & Relationship Questions 413.

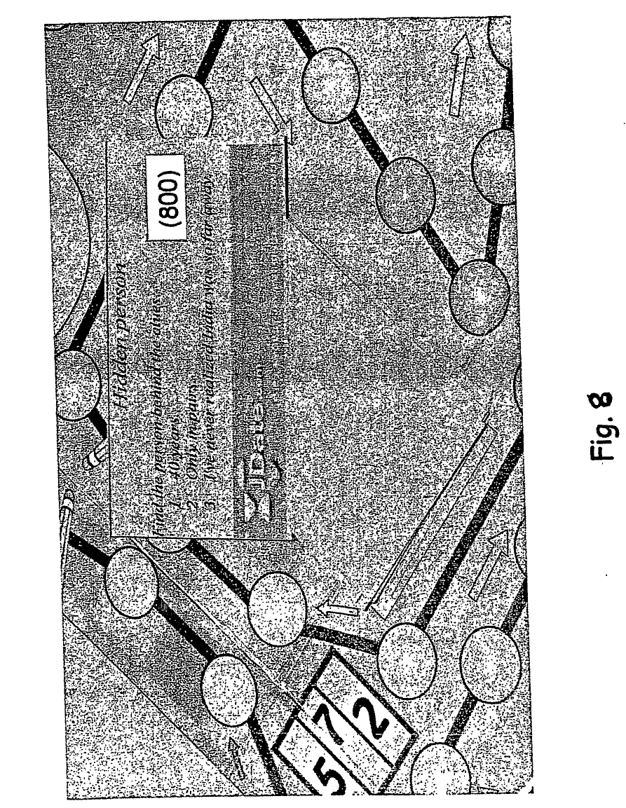

FIG. 8 shows an example of the card from the first category 800 with Initial General/Introduction/Background Questions off the board game shown in FIG. 4.

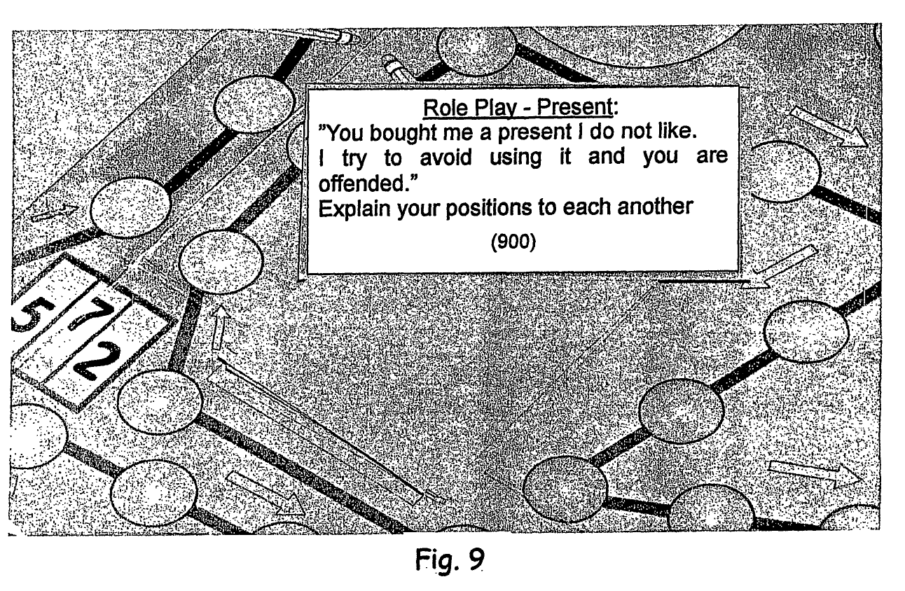

FIG. 9 shows an example of the card from the second category 900 with Timed Activities & “Role Play” in playing the board game shown in FIG. 4.

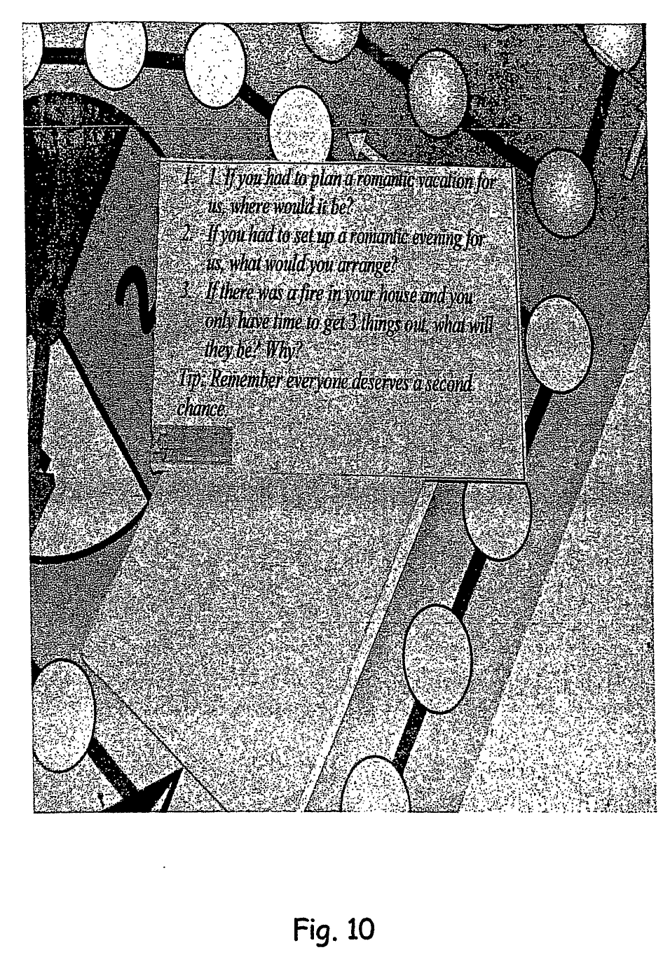

FIG. 10 shows an example of the card from the third category 1000 with Sex & Intimate & Relationship Questions in playing the board game shown in FIG. 4.

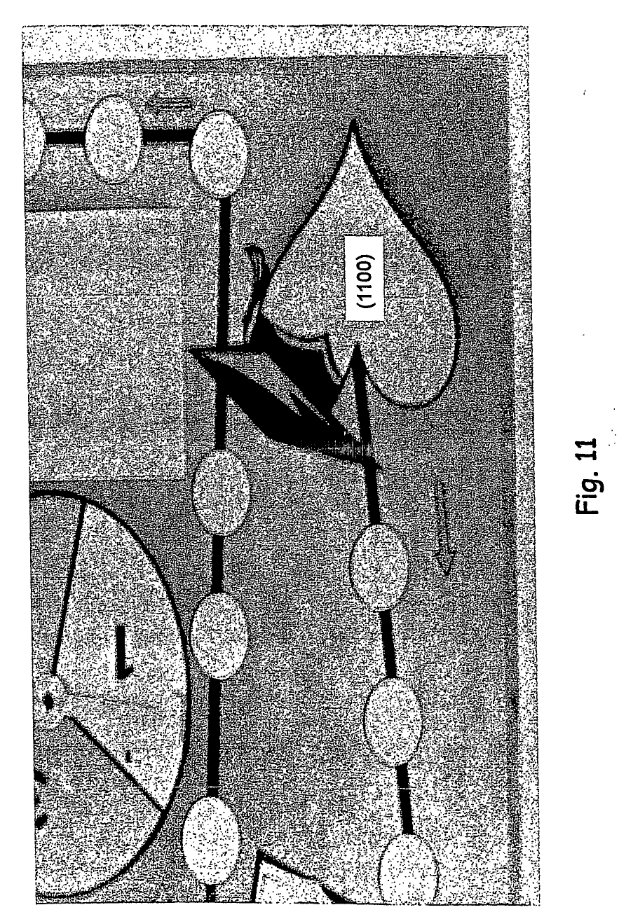

FIG. 11 shows a starting space 1100 of the board game shown in FIG. 4.

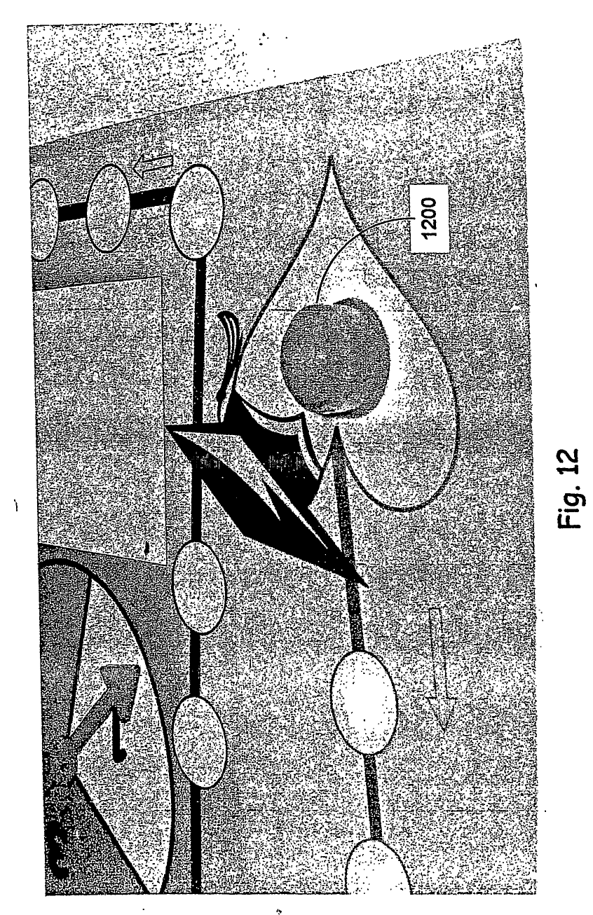

FIG. 12 shows the starting space shown in FIG. 11 with a game piece 1200 placed by the player in the board game shown in FIG. 4.

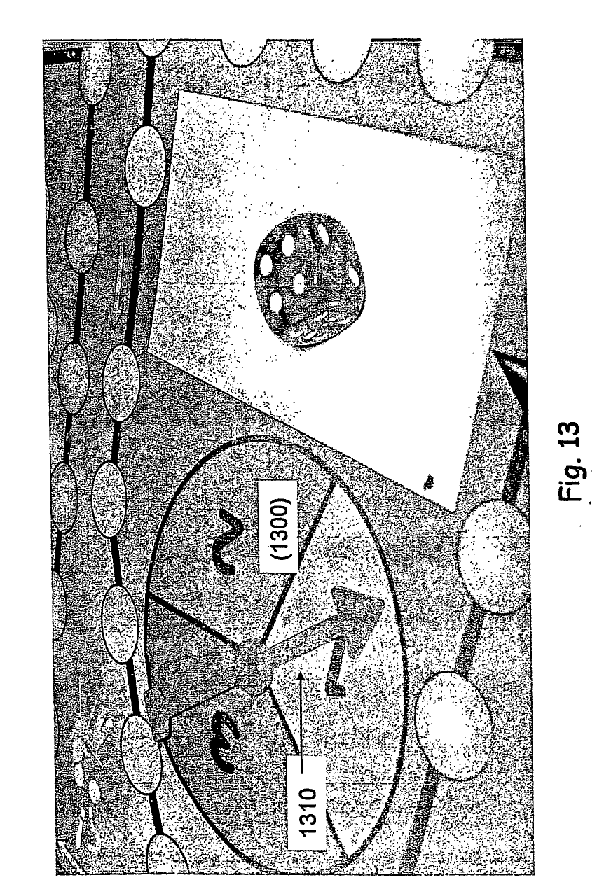

FIG. 13 shows an exemplary spinner 1300 for generating a random number selected from 1, 2 and 3, corresponding to the respective categories. When the player clicks this application the arrow 1310 of spinner 1300 will turn around and point to a random selection of the number. This number will indicate which question the user has to answer.

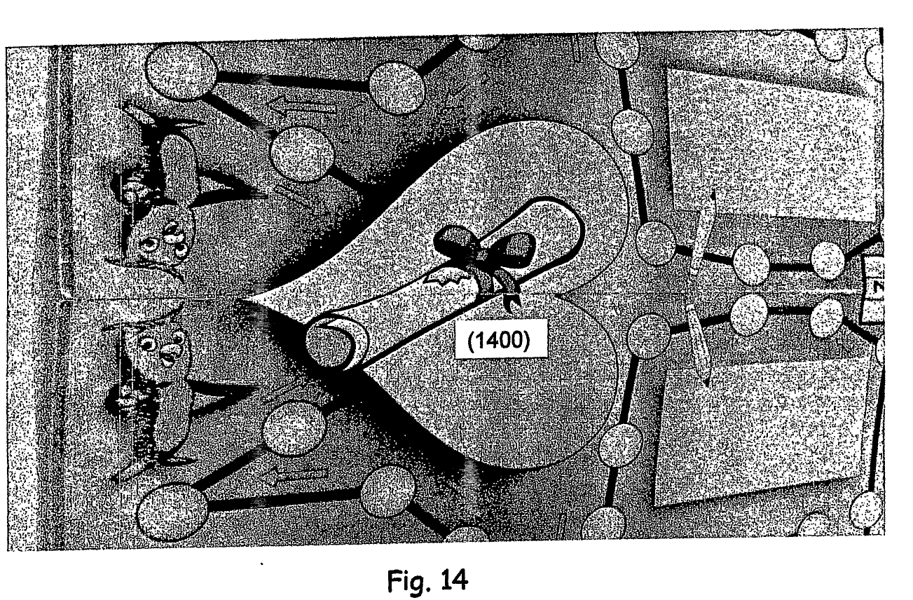

FIG. 14 shows an Ending Point 1400 on the board game shown in FIG. 4.

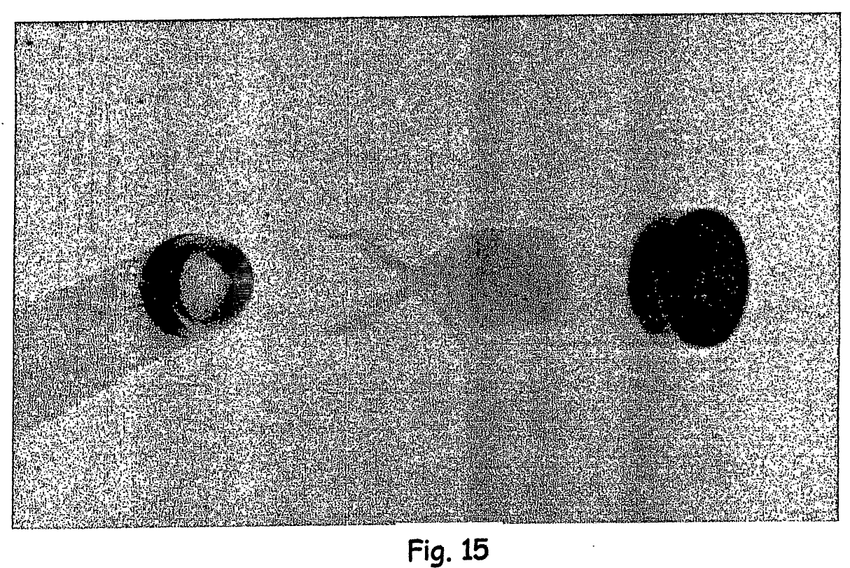

FIG. 15 shows a timer 1500, as used in the board game shown in FIG. 4.

Game Playing Description:

1. The game stars when the two players are positioned at the starting spaces.
2. One of the players rolls the game die and moves the game piece the number of spaces, according to the die result.
3. An Initial General/Introduction/Background Question card appears on a screen for the second user to answer. The card includes, for example, three questions, as shown above.
4. The second player clicks on the spinner in order to generate a random number indicative of a number of the question to be selected from the three questions presented on the card.
5. The question is thereby selected.
6. The second player answers the question, for example, by using a chat system or a messenger application.
7. End of the turn of the first player.
8. Thereafter the play continues mutatis mutandis until the players arrive at the second portion of the game board: Timed Activities & “Role Play.
9. During the Timed Activities & “Role Play stage the player who arrives first at this board portion rolls the die and moves the game piece forward, according to the die result. A Timed Activities & “Role Play” game card appears. At this stage the players play an activity, or “role play,” with the applications provided with the game, such as a timer (e.g., Sand Clock), Playing Cars, Painter, etc.
10. Finally, the players start the Sex & Intimate & Relationship (10) on the red track when the Timed Activities & “Role Play portion of the board ends.
11. At this stage, the leading player rolls the game die and moves the game pieces forward, according to the die result.
12. A Sex, Intimate & Relationship card appears on the screen for the second user to be answered that including three questions, as described above.
13. The second player clicks on the spinner in order to choose a question from the three suggested by the card.
14. The question is thereby selected.
15. The player answers the question using the chat or messenger application.
16. End of the turn.
17. The players continue the game until one of the players or both of them arrive to the ending space of the game.
18. At the ending space the players can get original suggestions for their first real date.
19. At the end of game the happy couple can ready for their first date.

As such, those skilled in the art to which the present invention pertains, can appreciate that while the present invention has been described in terms of preferred embodiments, the concept upon which this disclosure is based may readily be utilized as a basis for the designing of other structures, systems and processes for carrying out the several purposes of the present invention.

Although the game has been described with the participation of two players, should be appreciated that the game can be played with any number of players, greater than or equal to two.

Although the game and the questions asked of the players were oriented towards a romantic first date, it should also be understood that the invention is not limited to this application. The board of the game, questions and the activities can be related to dating between students and other social groups.

Moreover, any reference to a specific implementation, in terms of usage of the chat application, the messenger or any other components are shown by way of a non-limiting example. It should be appreciated that when desired, the system can provide an audio or video communication between the users as well.

It is to be understood that the phraseology and terminology employed herein are for the purpose of description, and should not be regarded as limiting.

It is important, therefore, that the scope of the invention is not construed as being limited by the illustrative embodiments set forth herein. Other variations are possible within the scope of the present invention as defined in the appended claims and their equivalents.

1. A method for filling a psychological gap during the communication of at least two people considering making a date, the method characterized by playing a dating game by the at least two people on a game board having a plurality of spaces, the dating game comprising:
obtaining a game board by each player;
picking a game piece by each player that represents him/her during the game;
moving alternately by said players of his/her game piece on the game board from space to space from start to finish, wherein the number of spaces that said game piece moves is indicated by a random number indicator, and wherein the spaces on the board belong to a plurality of categories;
picking a category card by a player according to the category associated with the space on which the game piece lands, wherein said category card is printed as one of the following:
a question card having at least one question; and
an activity card showing a timed activity for him/her to carry out, such that at the end of the game the players decide whether to go out on a real date.

2. The method of claim 1, wherein said indicator is a die.

3. The method of claim 1, wherein said timed activity is carried out alone.

4. The method of claim 1, wherein said timed activity is carried out with another player.

5. The method of claim 1, wherein for the case of a question card, more than one question is presented on each card, so that the second player could select which of the questions the first player has to answer.

6. The method of claim 1, wherein a list of said categories includes:
an introduction category;
a timed activities category; and
an intimate questions category.

7. The method of claim 1, wherein a board of the board game is a virtual board monitored by a computer.

8. The method of claim 1, constructed to operate on a dating game system comprising:
a game board;
a game piece for each player; and
a plurality of printed cards for each of a plurality of categories.

9. A method for filling a psychological gap during the communication of two people considering making a date, one of whom is an inviter and the other is an invited, the method characterized by playing a dating game over an electronic network by the two people comprising:
uploading the game program by each player;
choosing a character image screen by each player that represents him/her during the game;
choosing a location screen to represent a site for the playing of the game;
clicking the “next” button by the invited player, resulting in screens for each player showing both character images and information about the other player;
appearing on said location screen of a meeting table with three “rolling hearts” and a moderator figure who alternately asks each player a question;
clicking first by one player on the “Arrow to choose a question heart (1 to 3);”
“opening” of the heart with the matching number and presentation of a question to the other player to answer; wherein both players can see the question and they are able to discuss the presented question using a chat system/instant messaging (IM)/microphone/WebCam™; and wherein from the moment the question is presented the players have X amount of time to communicate with each other; and
appearing of said moderator from time to time and providing the players with tips about relationships and explanations to the players about the category they are in, and about the next category,
such that at the end of the game the inviter and invitee decide whether to go out on a real date.

10. The method of claim 9, wherein the electronic network is the Internet.

11. The method of claim 9, wherein said dating game is played over a mobile phone network connected over the Internet.

12. The method of claim 9, wherein said dating game is played using video consoles, each having a set-top box.

13. The method of claim 9, wherein said dating game is played using interactive television.

14. The method of claim 9, wherein said dating game is played on an actual television show.
